(19) United States
(12) Patent Application Publication
(10) Pub. No.: US 2026/0291086 A1
(43) Pub. Date: Sep. 24, 2026

(54) CONNECTOR AND WIRE HARNESS

(71) Applicant: Yazaki Corporation, Tokyo (JP)

(72) Inventors: Masaaki IWABE, Shizuoka (JP); Yasuharu KONDO, Shizuoka (JP)

(73) Assignee: Yazaki Corporation, Tokyo (JP)

(21) Appl. No.: 19/546,508

(22) Filed: Feb. 23, 2026

(30) Foreign Application Priority Data
Mar. 19, 2025 (JP) 2025-044449

(51) Int. Cl. H01R 4/30; H01R 4/34

(52) U.S. Cl. CPC H01R 4/305; H01R 4/34

(57) ABSTRACT

A connector includes a connector terminal, a housing, an electric wire with a terminal, and a cover. The housing is provided with an accommodation space part whose one end side in an assembly direction is opened, and a tip end of an electric wire electrically connected to the connector terminal is drawn into the accommodation space part. The housing is integrally provided with an insert bolt (bolt) protruding into the accommodation space part along the assembly direction. The insert bolt of the housing is inserted into a first fitting hole of the connector terminal and a second fitting hole of a terminal along the assembly direction, and is fastened by a nut.

### CROSS-REFERENCE TO RELATED APPLICATION(S)

The present application claims priority to and incorporates by reference the entire contents of Japanese Patent Application No. 2025-044449 filed in Japan on March 19, 2025.

### BACKGROUND OF THE INVENTION

### 1. Field of the Invention

The present invention relates to a connector and a wire harness.

### 2. Description of the Related Art

As a conventional technology relating to a connector and a wire harnesses, for example, Japanese Patent Application Laid-open No. JP 2014 - 220 933 A discloses a round terminal fixing structure in which a round terminal connected to an end of an electric wire is overlapped with a bus bar and fixed with a bolt. The round terminal includes a bolt insertion part formed with a first through hole through which a bolt is passed, and a core wire crimping part that crimps the core wire of the electric wire. The bus bar includes a flat plate part formed with a second through hole through which a bolt is passed, and a standing piece that is erected from the flat plate part, and that prevents the round terminal from rotating, by coming into contact with the core wire crimping part when the round terminal is bolted.

Incidentally, in the round terminal fixing structure disclosed in Japanese Patent Application Laid-open No. JP 2014 – 220 933 A described above, for example, a bolt is inserted after the first through hole of the round terminal and the second through hole of the bus bar are positioned. Hence, there is a concern that the workability of assembling work may be deteriorated.

### SUMMARY OF THE INVENTION

The present invention has been made in view of the above circumstances, and an object of the present invention is to provide a connector and a wire harness that can improve the workability of assembling work.

In order to achieve the above mentioned object, a connector according to one aspect of the present invention includes a connector terminal electrically connected to a mating terminal of a mating connector; a housing provided with an accommodation space part whose one end side in an assembly direction is opened, and a tip end of an electric wire electrically connected to the connector terminal is drawn into the accommodation space part; an electric wire with a terminal that includes the electric wire accommodated in the accommodation space part, and a terminal provided on the tip end of the electric wire; and a cover that covers the accommodation space part from the one end side in the assembly direction, wherein the housing is integrally provided with a bolt protruding into the accommodation space part along the assembly direction, andthe bolt of the housing is inserted into a first fitting hole of the connector terminal and a second fitting hole of the terminal along the assembly direction, and is fastened by a nut.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire harness to which a connector according to an embodiment is applied;

FIG. 2 is an exemplary exploded perspective view of the connector according to the embodiment;

FIG. 3 is an exemplary exploded perspective view of the connector according to the embodiment, as viewed from an angle different from that in FIG. 2;

FIG. 4 is an exemplary plan view of the connector according to the embodiment, when a cover and an upper shell are removed;

FIG. 5 is an exemplary plan view of the vicinity of a bolt and a connector terminal of the connector according to the embodiment;

FIG. 6 is an exemplary plan view of the vicinity of the bolt and the connector terminal of the connector according to the embodiment, when the terminal of an electric wire with a terminal is rotated with respect to FIG. 5;

FIG. 7 is an exemplary perspective view of the connector terminal of the connector according to the embodiment;

FIG. 8 is an enlarged view of the connector terminal in FIG. 7; and

FIG. 9 is an exemplary sectional view of the vicinity of the bolt of the connector according to the embodiment.

### DETAILED DESCRIPTION OF THE PREFERRED EMBODIMENTS

Hereinafter, an embodiment according to the present invention will be described in detail with reference to the drawings. However, this invention is not limited to the following embodiment. Moreover, the components in the following embodiment include those that can be easily replaced by those skilled in the art, or those that are substantially the same. In the present specification, ordinal numbers are used only to distinguish components, members, parts, positions, directions, and the like, and do not indicate order or priority.

### Embodiment

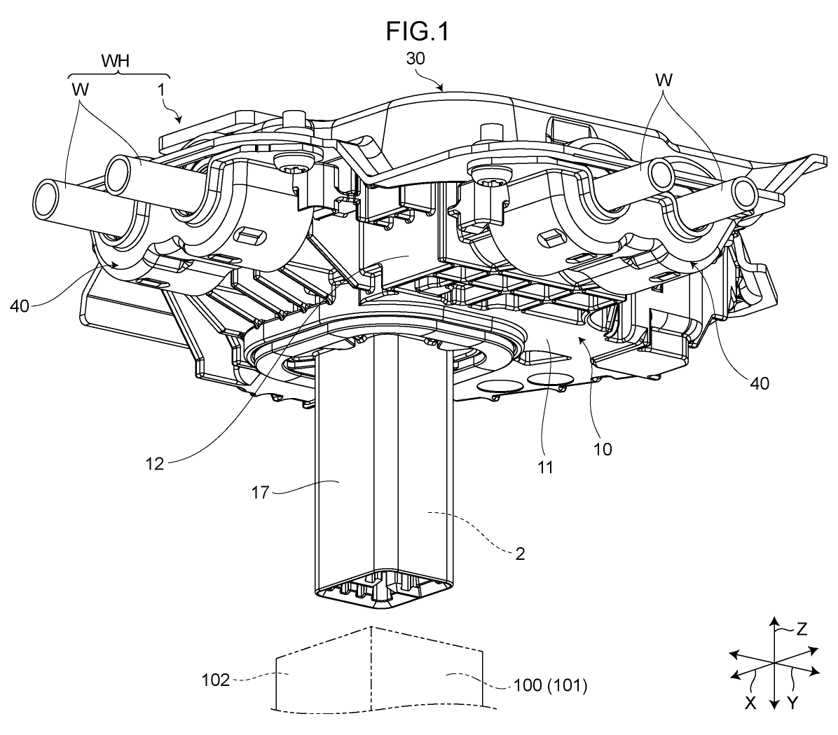

FIG. 1 is a perspective view of a wire harness WH to which a connector 1 according to an embodiment is applied. For example, the connector 1 in the present embodiment illustrated in FIG. 1 includes a connector part 17, and is fitted to a fitting part 101 of a mating connector 100. In this example, the connector 1 is a male connector into which tip ends of a plurality of electric wires W with terminals are drawn, and in which the connector part 17 is a connection part. The mating connector 100 is a female connector in which the fitting part 101 is a connection part. For example, the connector 1 is incorporated into a wire harness WH routed in a vehicle such as an automobile. In order to achieve electrical connection between devices mounted on a vehicle, for example, the wire harness WH is formed as a component assembly by bundling wiring members used for power supply and signal communication, and the wiring members of the component assembly are connected to each of the devices via the connecting portion 17 or the like. For example, the wire harness WH includes the electric wires W with terminals serving as wiring members, the connector 1 provided to the ends of the electric wires W with terminals, and the mating connector 100 electrically and mechanically connected to the connector 1. In addition, the wire harness WH may also include various other components such as a fixture, a protector, and a grommet.

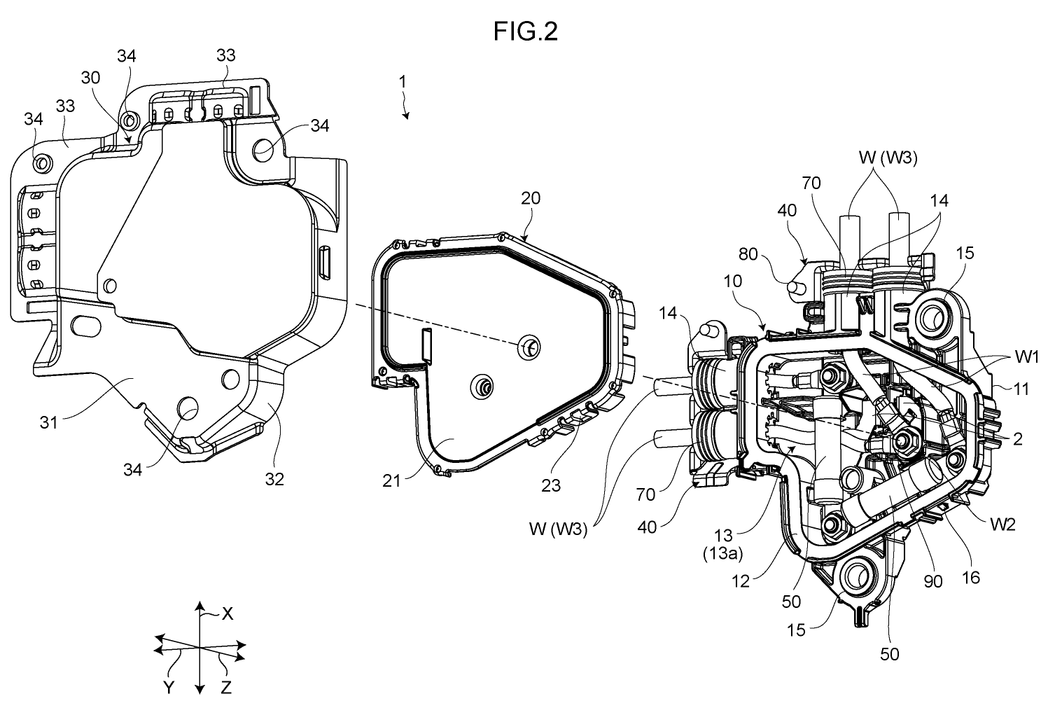

In the following description, among a first direction, a second direction, and a third direction intersecting each other, the first direction is referred to as a "first intersecting direction X", the second direction is referred to as a "second intersecting direction Y", and the third direction is referred to as an "assembly direction Z". In this example, the first intersecting direction X, the second intersecting direction Y, and the assembly direction Z are substantially orthogonal to each other. The first intersecting direction X typically corresponds to the front-back direction of the connector 1, the axial direction of a pair of two electric wires W with terminals (first electric wire with a terminal), or the like. The second intersecting direction Y typically corresponds to the width direction of the connector 1, the axial direction of another pair of two electric wires W with terminals (second electric wire with a terminal), or the like. The assembly direction Z typically corresponds to the height direction (vertical direction) of the connector 1, the fitting direction (insertion/extraction direction) of the connector 1 and the mating connector 100, the opening direction of an accommodation space part 13 of a housing 10 (see FIG. 2), which will be described below, the assembly direction (laminating direction) of the housing 10 and a cover 20, or the like. Unless otherwise specified, each direction used in the following description refers to a direction in a state in which the wire harness WH is assembled to the vehicle.

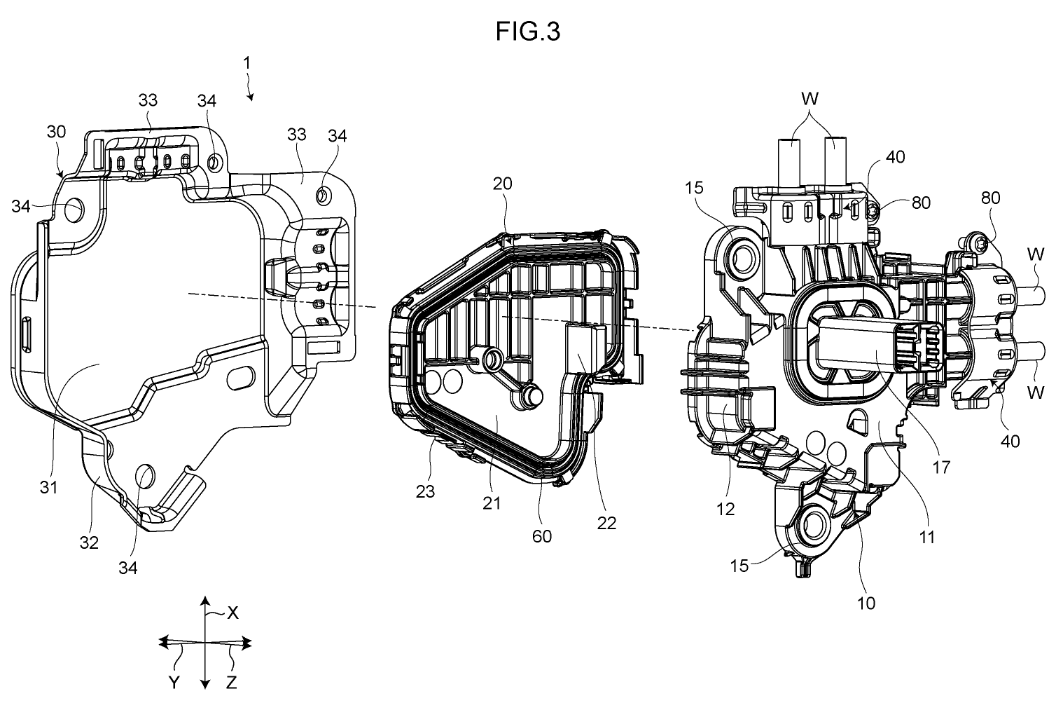

FIG. 2 is an exploded perspective view of the connector 1. FIG. 3 is an exploded perspective view of the connector 1, as viewed from an angle different from that in FIG. 2. As illustrated in FIGS. 2 and 3, for example, the connector 1 includes the housing 10, the cover 20, an upper shell 30, a lower shell 40, a fuse 50, a packing 60, a wire packing 70, a fastening member 80, and an insert bolt 90, which will be described below. The housing 10 is provided with the accommodation space part 13 whose one end side in the assembly direction Z is opened. The accommodation space part 13 is a space part that accommodates the tip end of an electric wire W1 of the electric wires W with terminals, the fuse 50, and the like. In the housing 10 of the present embodiment, a pair of two electric wires W with terminals (first electric wire with a terminal) is drawn into the accommodation space part 13 along the first intersecting direction X, and another pair of two electric wires W with terminals (second electric wire with a terminal) is drawn into the accommodation space part 13 along the second intersecting direction Y.

For example, the electric wire W with a terminal includes the electric wire W1, a terminal W2 provided on the tip end of the electric wire W1, and an insulating sheath W3 provided on the outer periphery of the electric wire W1. For example, the electric wire W1 includes a linear conductive part having conductivity, and an insulating coating part having an insulating property that covers the outside of the conductive part. The conductive part is a core wire obtained by bundling a plurality of metal strands having conductivity, a twisted core wire obtained by twisting together the metal strands, and the like. The insulating coating part is an electric wire coating that coats the outer peripheral side of the conductive part. For example, the terminal W2 is a round terminal or the like, and is bonded to the core wire exposed from the tip end of the electric wire W1, by caulking, laser welding, or the like. For example, the sheath W3 is an insulating coating that coats the outer peripheral side of the electric wire W1, and covers the outer peripheral surface of the electric wire W1 of a portion located outside the accommodation space part 13.

In the present embodiment, a shielding material, which is not illustrated, is provided between the electric wire W1 and the sheath W3. The shielding material prevents noise from entering the core wire of the electric wire W1. For example, the shielding material may be a braided body obtained by braiding a metal linear conductor into a mesh shape and a cylindrical shape, or may be a metal foil material (what is called a metal foil) formed into a cylindrical shape. For example, the shielding material is electrically connected to a shield terminal, which is not illustrated. The shield terminal is a metal member formed into a cylindrical shape. In the shield terminal, the wire packing 70 that stops water from entering the outer peripheral surface of the sheath W3 of each electric wire W with a terminal, and that holds the shield terminal with respect to each electric wire W with a terminal is provided.

For example, the housing 10 is formed of a resin material having an insulating property. For example, the housing 10 includes a bottom wall 11, a peripheral wall 12, an electric wire insertion part 14, a fitting part 15, an engaging part 16, and a connector part 17. The bottom wall 11 and the peripheral wall 12 are structural bodies for partitioning the accommodation space part 13 described above. The accommodation space part 13 is a space part that accommodates the tip ends of the electric wires W1, the fuse 50, and the like, and is opened toward the one end side in the assembly direction Z. In the present embodiment, the bottom wall 11, the peripheral wall 12, the electric wire insertion part 14, the fitting part 15, and the engaging part 16 form the housing main body of the housing 10. The connector part 17 (see FIG. 3) is provided on the outer surface of the bottom wall 11 of the housing main body on the opposite side to the accommodation space part 13, and protrudes from the outer surface toward the other end side in the assembly direction Z. For example, the connector part 17 is formed in a rectangular tube shape, and a plurality of connector terminals 2 are provided inside. For example, each of the connector terminals 2 is a male terminal electrically connected to a female mating terminal 102 of the mating connector 100 (see FIG. 1), and is held inside the connector part 17.

For example, the electric wire insertion part 14 is provided on the outer surface of the peripheral wall 12 of the housing main body on the opposite side to the accommodation space part 13. In the present embodiment, on the peripheral wall 12, two of the electric wire insertion parts 14 that are aligned side by side along the second intersecting direction Y are provided on one end in the first intersecting direction X, and two of the electric wire insertion parts 14 that are aligned side by side along the first intersecting direction X are provided on one end in the second intersecting direction Y. Each of the electric wire insertion parts 14 is formed in a substantially cylindrical shape, and communicates with the accommodation space part 13. In other words, on the peripheral wall 12, an opening part that communicates the inner space of each electric wire insertion part 14 with the accommodation space part 13 is provided. Each of the electric wires W with terminals is inserted into each electric wire insertion part 14, and the tip end of each electric wire W1 is drawn into the accommodation space part 13.

For example, the fitting part 15 is provided on the outer surface of the peripheral wall 12 of the housing main body on the opposite side to the accommodation space part 13, at a position shifted from the electric wire insertion part 14. The fitting part 15 protrudes along the first intersecting direction X. In the present embodiment, on the peripheral wall 12, two of the fitting parts 15 are provided on both ends in the first intersecting direction X. Each of the fitting parts 15 is provided with an insertion hole through which a fastening member such as a bolt is inserted along the assembly direction Z. For example, the housing 10 is fixed to a vehicle, when each fitting part 15 is fastened to the fitting part on the vehicle side with the upper shell 30 by a fastening member.

For example, the engaging part 16 is provided on the outer surface of the peripheral wall 12 of the housing main body on the opposite side to the accommodation space part 13, at a position shifted from the electric wire insertion part 14 and the fitting part 15. The engaging part 16 is formed in a claw shape on the outer surface. In the present embodiment, on the peripheral wall 12, a plurality of the engaging parts 16 may be provided at intervals. Each of the engaging parts 16 has an engaging surface that faces a part to be engaged 23 provided on the cover 20 along the assembly direction Z. For example, the housing 10 is integrated with (fixed to) the cover 20, when each engaging part 16 is engaged to the part to be engaged 23 along the assembly direction Z.

For example, the cover 20 is formed of a resin material having an insulating property. For example, the cover 20 includes a cover main body 21, a rib 22 (see FIG. 3), and the part to be engaged 23. The cover main body 21 covers the accommodation space part 13, from one end side in the assembly direction Z in the cover 20. The rib 22 protrudes from the cover main body 21 toward the other end side (into the accommodation space part 13) in the assembly direction Z, and prevents the interference of the electric wire W1 and the fuse 50. The part to be engaged 23 is provided on the outer peripheral part of the cover main body 21, and is engaged to the engaging part 16 on the housing 10 side as described above, along the assembly direction Z. For example, the cover main body 21 is formed in a substantially flat plate shape, along the external shape of the peripheral wall 12 of the housing 10. In the present embodiment, the packing 60 is provided between the cover 20 and one end surface of the peripheral wall 12 in the assembly direction Z, along the opening edge part of the accommodation space part 13.

The packing 60 prevents foreign matters such as moisture from entering the accommodation space part 13 through a gap between the housing 10 and the cover 20. For example, the packing 60 is formed of an elastically deformable material such as rubber or resin. For example, the packing 60 is formed in a ring shape along the opening edge part of the accommodation space part 13. The packing 60 stops water from flowing between the cover 20 and the peripheral wall 12 of the housing 10, by being fitted between the cover 20 and the peripheral wall 12 of the housing 10 in a compressed state.

For example, the upper shell 30 is formed in a substantially shell shape by a metal material having conductivity. Specifically, for example, the upper shell 30 includes a top plate 31, and a peripheral wall 32 protruding from the peripheral edge part of the top plate 31 toward the other end side in the assembly direction Z. The peripheral wall 32 is partially provided around the top plate 31 in an intermittent manner. Moreover, a flange-shaped holding plate 33 is provided on the peripheral wall 32 of the upper shell 30 corresponding to the electric wire insertion part 14 of the housing 10. The upper shell 30 formed in this manner is fitted to the housing 10 so as to cover the cover 20. For example, the upper shell 30 is fastened to the lower shell 40 by the fastening member 80 such as a bolt that is inserted into some of a plurality of insertion holes 34 provided on the top plate 31, and is fastened to the housing 10 by a fastening member such as a bolt that is inserted into the remaining insertion holes 34.

For example, the lower shell 40 is formed in a substantially shell shape by a metal material having conductivity. Specifically, for example, the lower shell 40 is formed in a substantially semi-circular cylindrical shape along the wire packing 70 of the pair of two electric wires W with terminals. The lower shell 40 holds the wire packing 70 and a shield terminal, which is not illustrated, together with the holding plate 33 of the upper shell 30. The housing 10 of the present embodiment is fitted with a plurality of the lower shells 40 corresponding to the pairs of electric wires W with terminals.

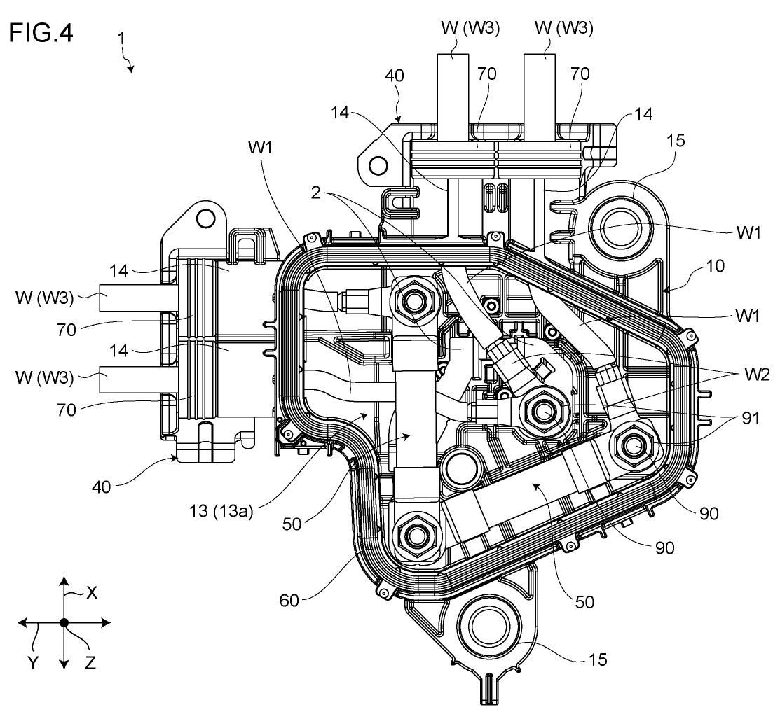

FIG. 4 is a plan view of the connector 1. As illustrated in FIG. 4, for example, the fuse 50 is a circuit protection component provided between the connector terminal 2 and the electric wire W with a terminal, and that causes a fuse part to blow out, when an overcurrent flows between the connector terminal 2 and the electric wire W with a terminal. In the present embodiment, a plurality of the fuses 50 are provided in the accommodation space part 13, and one of the fuses 50 is interposed between the first connector terminal 2 and one of the pair of two electric wires W with terminals (first electric wire with a terminal) that is drawn into the accommodation space part 13 along the first intersecting direction X. Moreover, the other fuse 50 is interposed between the first connector terminal 2 and one of the pair of two electric wires W with terminals (second electric wire with a terminal) that is drawn into the accommodation space part 13 along the second intersecting direction Y.

Furthermore, the fuses 50 are accommodated in the accommodation space part 13 together with the electric wires W1 of the electric wires W with terminals. Then, in the present embodiment, while one of the fuses 50 is disposed so as not to overlap with the electric wire W1 in the assembly direction Z, the other fuse 50 is disposed so as to overlap with the electric wire W1 in the assembly direction Z. Specifically, the other fuse 50 is disposed on the one end side of the electric wire W1 in the assembly direction Z, while intersecting the electric wire W1. In the present embodiment, the electric wire W1 intersecting the fuse 50 is the electric wire W1 of the electric wire W with a terminal that is electrically connected to the second connector terminal 2. Thus, in the present embodiment, the electric wires W1 are densely provided so as to intersect the energized (conductive) fuse 50 in the accommodation space part 13.

In this example, the housing 10 of the present embodiment is integrally provided with a plurality of the insert bolts 90 protruding into the accommodation space part 13 along the assembly direction Z. Then, the fuse 50, the pair of connector terminals 2, the terminal W2 of each of the electric wires W with terminals, and the like are fitted to the insert bolt 90 of the housing 10, and are fastened by a nut 91. Each of a plurality of the terminals W2 is a round terminal or the like, and is provided with a second fitting hole W2a through which each of the insert bolts 90 is inserted along the assembly direction Z. The terminal W2 is not limited to the round terminal, and may also be a terminal having another shape or the like. In the present embodiment, the insert bolt 90 is an example of a bolt.

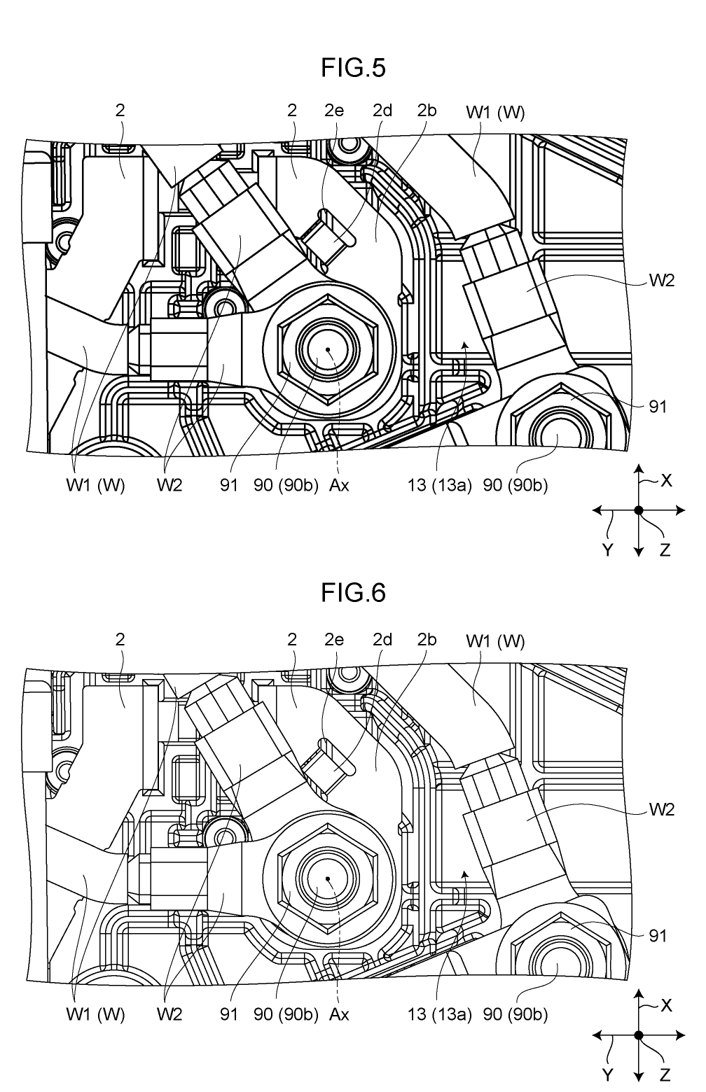

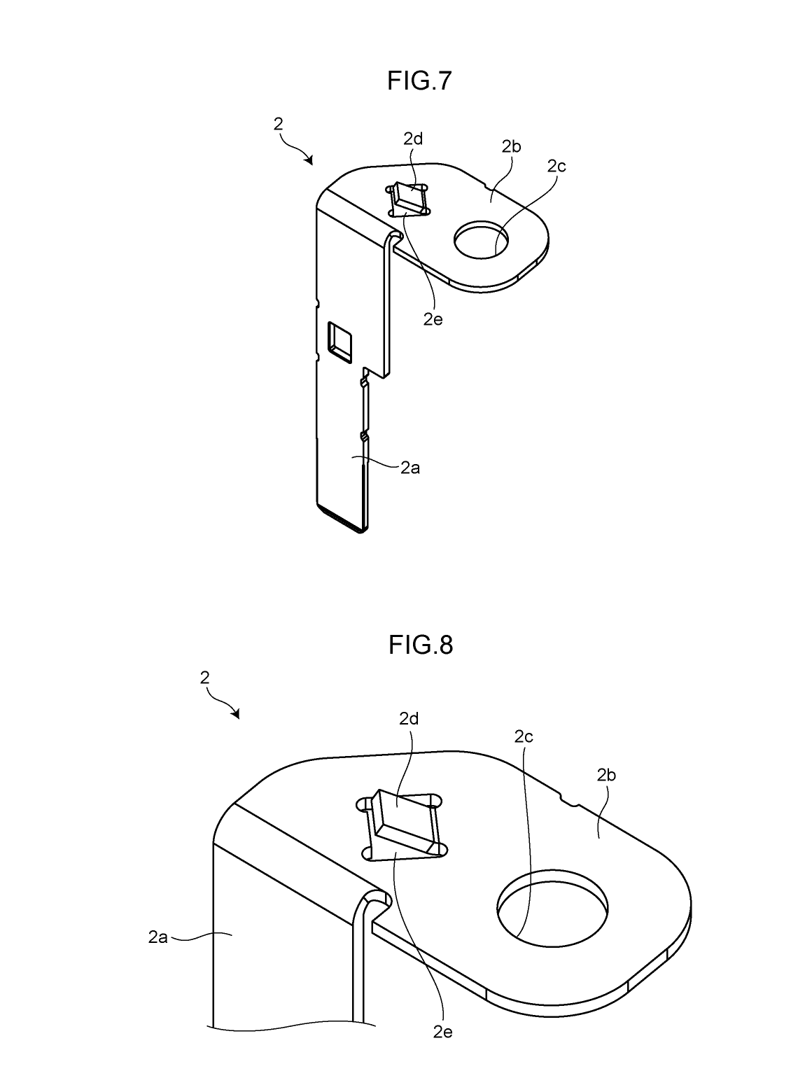

FIG. 5 is a plan view of the vicinity of the insert bolt 90 and the connector terminal 2 of the connector 1. FIG. 6 is a plan view of the vicinity of the insert bolt 90 and the connector terminal 2 of the connector 1, when the terminal W2 of the electric wire W with a terminal is rotated with respect to FIG. 5. FIG. 7 is a perspective view of the connector terminal 2 of the connector 1. FIG. 8 is an enlarged view of the connector terminal 2 in FIG. 7. As illustrated in FIGS. 5 to 8, for example, the connector terminal 2 includes an electric connection part 2a and a bolt fitting part 2b. The connector terminal 2 illustrated in FIGS. 5 to 8 is the second connector terminal 2, and is different from the first connector terminal 2 (the fuse 50 side) in that a rotation prevention piece 2d is provided on the bolt fitting part 2b. The other configurations are substantially the same.

The electric connection part 2a is a portion that is electrically connected to the mating terminal 102 of the mating connector 100. The electric connection part 2a extends in a strip-plate shape along the assembly direction Z, and is held inside the connector part 17 as described above. The bolt fitting part 2b is a portion to which the insert bolt 90 is fitted. The bolt fitting part 2b is provided on one end of the electric connection part 2a in the assembly direction Z, and extends in a flange shape from the one end along the second intersecting direction Y. The bolt fitting part 2b is provided with a first fitting hole 2c through which the insert bolt 90 is inserted along the assembly direction Z.

The rotation prevention piece 2d is a portion that prevents the terminal W2 from rotating with respect to the insert bolt 90, around a rotation center Ax that extends along the assembly direction Z. Specifically, the rotation prevention piece 2d prevents the terminal W2 from rotating around the rotation center Ax with respect to the insert bolt 90, due to the rotational torque generated when the insert bolt 90 and the nut 91 are fastened to each other, by coming into contact with the terminal W2. In the present embodiment, the bolt fitting part 2b is provided with a notch 2e where the rotation prevention piece 2d is formed. Then, the rotation prevention piece 2d is formed by cutting and raising the edge part of the notch 2e. For example, the rotation prevention piece 2d is inclined so as to separate from the bolt fitting part 2b toward the one end side in the assembly direction Z, from the base end side connected to the bolt fitting part 2b toward the tip end side.

Moreover, for example, the rotation prevention piece 2d functions as an electrical contact to the terminal W2. Specifically, the rotation prevention piece 2d ensures the conduction performance, by increasing the portion electrically connected to the terminal W2 in the connector terminal 2, by coming into contact with the terminal W2. For example, the rotation prevention piece 2d faces the side surface of the terminal W2 in a close contact (adjacent) state, and comes into contact with the terminal W2, when the terminal W2 is rotated around the rotation center Ax with the fastening of the insert bolt 90 and the nut 91. In the present embodiment, a single rotation prevention piece 2d is provided on the bolt fitting part 2b. However, the example is not limited thereto, and for example, a plurality of the rotation prevention pieces 2d may also be provided.

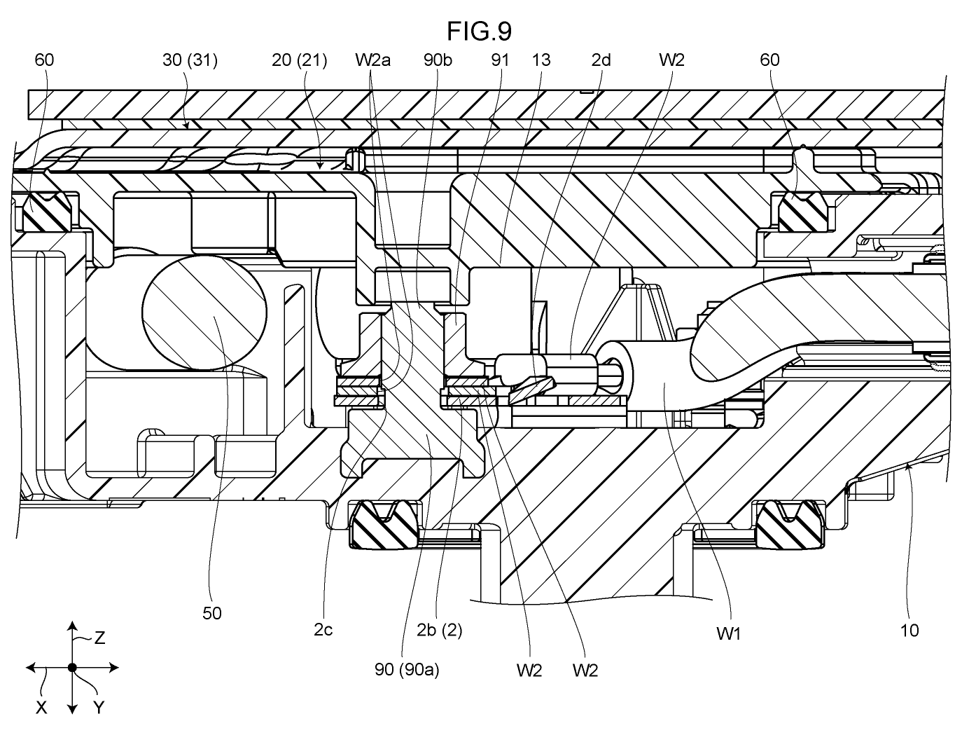

FIG. 9 is a sectional view of the vicinity of the insert bolt 90 of the connector 1. As illustrated in FIG. 9, for example, the insert bolt 90 includes a head part 90a and a shaft part 90b. The head part 90a is a portion to be buried in the bottom wall 11 (a bottom part 13a of the accommodation space part 13) of the housing 10, when the housing 10 and the insert bolt 90 are insert-molded (integrally molded). The head part 90a is engaged to a part of the bottom wall 11 along the assembly direction Z, to restrict the movement to one end side in the assembly direction Z. The shaft part 90b is a portion that extends from the head part 90a toward one end side in the assembly direction Z, and that protrudes into the accommodation space part 13. The shaft part 90b is provided with a male screw part that meshes with a female screw part of the nut 91.

In the connector 1 of the present embodiment having the above configuration, the connector terminal 2 and the terminal W2 are fitted to the insert bolt 90 of the housing 10. Specifically, the shaft part 90b of the insert bolt 90 is inserted into the first fitting hole 2c of the connector terminal 2 and the second fitting hole W2a of the terminal W2, and in this state, the male screw part of the shaft part 90b and the female screw part of the nut 91 are fastened together. In this process, in the present embodiment, the terminal W2 is prevented from rotating with respect to the insert bolt 90, because the rotation prevention piece 2d is brought into contact with the terminal W2. Moreover, a plurality of the second fitting holes W2a of the terminals W2 are fitted to the insert bolt 90 (see FIG. 9) corresponding to the second connector terminal 2, and are jointly tightened with the second connector terminal 2.

As described above, in the connector 1 and the wire harness WH of the present embodiment, the housing 10 is integrally provided with the insert bolt 90 (bolt) protruding into the accommodation space part 13 along the assembly direction Z. The insert bolt 90 of the housing 10 is inserted into the first fitting hole 2c of the connector terminal 2 and the second fitting hole W2a of the terminal W2 along the assembly direction Z, and is fastened by the nut 91. According to this configuration, for example, the connector 1 and the wire harness WH can easily align the first fitting hole 2c of the connector terminal 2 and the second fitting hole W2a of the terminal W2 with respect to the insert bolt 90. As a result, the connector 1 and the wire harness WH can improve the workability of assembling work.

Moreover, in the connector 1 and wire harness WH of the present embodiment, the electric wires W with terminals are provided in the accommodation space part 13, and the connector terminal 2 is fastened to the terminals W2 of the electric wires W with terminals by the insert bolt 90 and the nut 91. According to this configuration, for example, the connector 1 and the wire harness WH can also improve the workability of assembling work, in the configuration where the connector terminal 2 and the terminals W2 are fastened (jointly tightened) by the insert bolt 90 and the nut 91.

Furthermore, in the connector 1 and the wire harness WH of the present embodiment, the connector terminal 2 includes the rotation prevention piece 2d that prevents the terminal W2 from rotating around the rotation center Ax along the assembly direction Z, by coming into contact with the terminal W2. The rotation prevention piece 2d functions as an electrical contact to the terminal W2. According to this configuration, for example, with the rotation prevention piece 2d, the connector 1 and the wire harness WH can prevent the terminal W2 from rotating around the rotation center Ax with the fastening of the insert bolt 90 and the nut 91. In addition, the connector 1 and the wire harness WH can improve the conduction performance of the connector terminal 2 and the terminal W2.

In the present embodiment, the pair of fuses 50 is provided in the accommodation space part 13. However, the example is not limited thereto, and for example, one or three or more fuses 50 may be provided in the accommodation space part 13. Moreover, in the present embodiment, the tip ends of the four electric wires W with terminals are drawn into the accommodation space part 13. However, the example is not limited thereto, and for example, the tip ends of two or six or more electric wires W with terminals may be drawn into the accommodation space part 13.

The embodiment of the present invention has been described above. However, the embodiment described above is merely an example, and is not intended to limit the scope of the invention. The embodiment described above may be implemented in various other forms, and various omissions, substitutions, combinations, and changes may be made without departing from the gist of the invention. Moreover, the specifications of each configuration, shape, and the like (structure, type, direction, format, size, length, width, thickness, height, number, arrangement, position, material, and the like) may be modified as appropriate.

The connector and the wire harnesses according to the present embodiment can advantageously improve the workability of assembling work.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector, comprising:
a connector terminal electrically connected to a mating terminal of a mating connector;
a housing provided with an accommodation space part whose one end side in an assembly direction is opened, and a tip end of an electric wire electrically connected to the connector terminal is drawn into the accommodation space part;
an electric wire with a terminal that includes the electric wire accommodated in the accommodation space part, and a terminal provided on the tip end of the electric wire; and
a cover that covers the accommodation space part from the one end side in the assembly direction, wherein
the housing is integrally provided with a bolt protruding into the accommodation space part along the assembly direction, and
the bolt of the housing is inserted into a first fitting hole of the connector terminal and a second fitting hole of the terminal along the assembly direction, and is fastened by a nut.

2. The connector according to claim 1, wherein
a plurality of the electric wires with terminals are provided in the accommodation space part, and
the connector terminal is fastened to the terminals of the electric wires with terminals by the bolt and the nut.

3. The connector according to claim 1, wherein
the connector terminal includes a rotation prevention piece that prevents the terminal from rotating around a rotation center along the assembly direction by coming into contact with the terminal, and
the rotation prevention piece functions as an electrical contact to the terminal.

4. The connector according to claim 2, wherein
the connector terminal includes a rotation prevention piece that prevents the terminal from rotating around a rotation center along the assembly direction by coming into contact with the terminal, and
the rotation prevention piece functions as an electrical contact to the terminal.

5. A wire harness, comprising:
a connector; and
a mating connector electrically and mechanically connected to the connector, wherein
the connector includes
a connector terminal electrically connected to a mating terminal of the mating connector,
a housing provided with an accommodation space part whose one end side in an assembly direction is opened, and a tip end of an electric wire electrically connected to the connector terminal is drawn into the accommodation space part,
an electric wire with a terminal that includes the electric wire accommodated in the accommodation space part, and a terminal provided on the tip end of the electric wire, and
a cover that covers the accommodation space part from the one end side in the assembly direction,
the housing is integrally provided with a bolt protruding into the accommodation space part along the assembly direction, and
the bolt of the housing is inserted into a first fitting hole of the connector terminal and a second fitting hole of the terminal along the assembly direction, and is fastened by a nut.
